(19) United States
(12) Patent Application Publication
(10) Pub. No.: US 2007/0044334 A1
(43) Pub. Date: Mar. 1, 2007

(54) Wireless device with integrated level

(75) Inventor: Gustavo D. Leizerovich, Aventura, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/210,596

(22) Filed: Aug. 24, 2005

(51) Int. Cl. G01C 15/10

(52) U.S. Cl. 33/334

(57) ABSTRACT

An integrated level (10) in a wireless device (11) can include a wireless transceiver within a housing (13), a processor (19) coupled to the wireless transceiver, a presentation device such as a display (12) or speaker (17) coupled to the processor, and an accelerometer (18) coupled to the processor where the display can serve to visually simulate the function of a level. The integrated level can further include a reference plane (15) added to the housing for proper level operation. By orienting the housing and the reference plane over a measurement plane (20), a determination of a deviation from a vertical plane or a horizontal plane can become apparent on the display. The display of the integrated level can provide a graphic user interface with a simulated level having a three segmented vertical bubble representation (16) and a three segmented horizontal bubble representation (14).

### FIELD OF THE INVENTION

This invention relates generally to levels, and more particularly to a level integrated into a wireless device such as a phone.

### BACKGROUND OF THE INVENTION

Existing wireless devices are more frequently including accelerometers as a means of detecting motion for various applications. One application described in U.S. Patent Publication No. 20040192347 entitled “Motion Detecting Wireless Receiver And Signal Monitoring Method Therefore” by Leizerovich et. al, and assigned to Motorola, Inc., discusses a method of reducing current drain by reducing the monitoring of adjacent transceivers when a lack of movement is detected. In other applications, public safety devices such as radios can utilize an accelerometer to indicate that a person is down or that they have not moved for a predetermined period of time.

### SUMMARY OF THE INVENTION

Embodiments in accordance with the present invention can provide a level integrated with a wireless handset by utilizing an accelerometer and a display. A reference plane can be added the handset housing for proper level operation.

In a first embodiment of the present invention, an integrated level in a wireless device can include a wireless transceiver within a housing, a processor coupled to the wireless transceiver, a presentation device such as a display or speaker coupled to the processor, and an accelerometer coupled to the processor where the display serves to visually simulate the function of a level. The integrated level can further include a reference plane added to the housing for proper level operation. Note, the accelerometer can measure static acceleration in X-Y directions and can be accurately placed in the housing so that X and Y axes are parallel to the reference plane. By orienting the housing and the reference plane over a measurement plane, a determination of a deviation from a vertical plane or a horizontal plane can become apparent on the display. The display of the integrated level can provide a graphic user interface with a simulated level having a three segmented vertical bubble representation and a three segmented horizontal bubble representation.

In a second embodiment of the present invention, a level can include a wireless communication device having a transceiver and a processor within a housing, a display within the wireless communication device, a means for measuring a deviation from a reference plane on the housing, and a graphical user interface on the display for representing the deviation from the reference plane. The means for measuring can include, but is not necessarily limited to an accelerometer coupled to the processor where the display serves to visually simulate the function of a level. The accelerometer can measure static acceleration in X-Y directions and can be accurately placed in the housing so that X and Y axes are parallel to a reference plane. As discussed above, by orienting the housing and the reference plane over a measurement plane, a determination of a deviation from a vertical plane or a horizontal plane becomes apparent on the display. The graphic user interface can provide a simulated level having a vertical bubble representation or a horizontal bubble representation or a combination of both. Furthermore the simulated level can have a three segmented vertical bubble representation and a three segmented horizontal bubble representation.

In a third embodiment of the present invention, a method of simulating a level function on a wireless communication device can include the steps of forming a reference plane on a housing for the wireless communication device, measuring a deviation from the reference plane using an accelerometer, and representing the deviation from the reference plane on a display within the wireless communication device. Representing the deviation can be done by displaying a representation of the deviation on a graphical user interface in the form of a simulated level. The simulated level can have vertical bubble, or a horizontal bubble, or a combination and in one embodiment can have a representation of a three segmented vertical bubble representation with a three segmented horizontal bubble representation.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an integrated level in a wireless communication device in accordance with an embodiment of the present invention.

FIG. 2 is an accelerometer used in conjunction with the integrated level of FIG. 1 in accordance with an embodiment of the present invention.

FIG. 3 is a flow chart illustrating a method of simulating a level function in a wireless communication device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

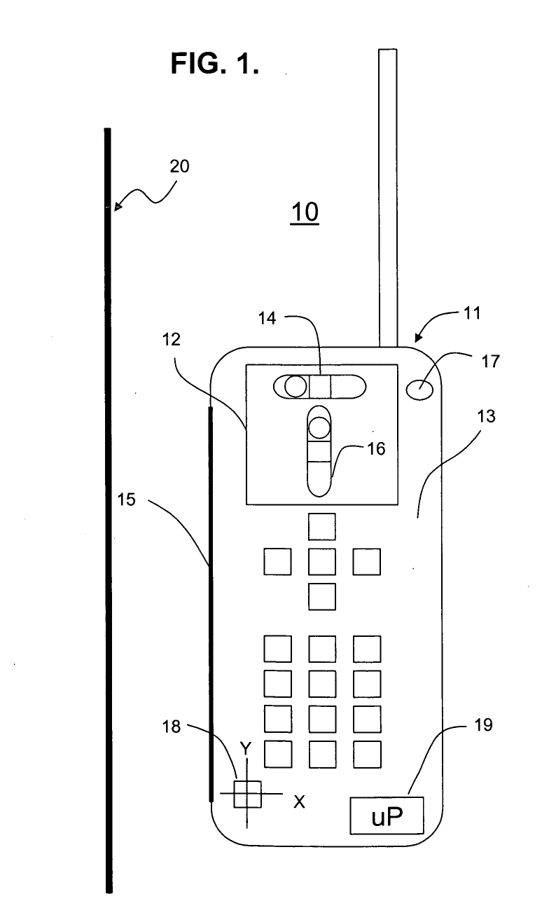

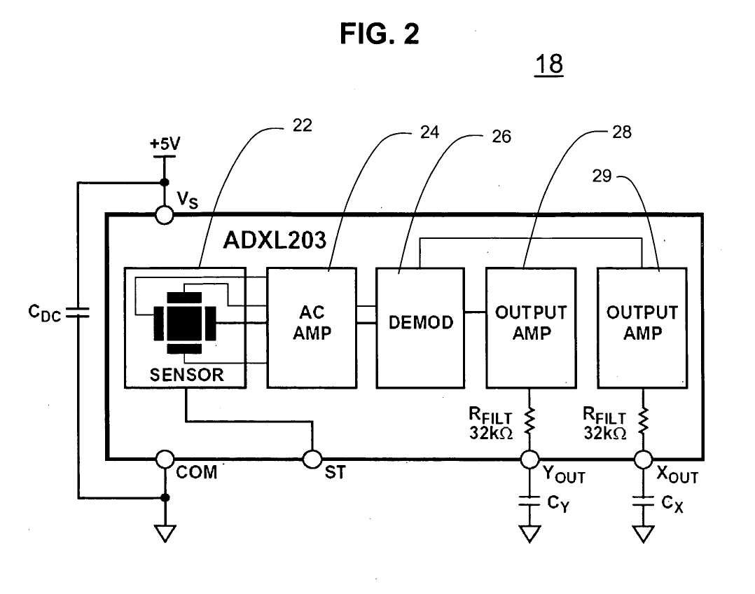

Referring to FIG. 1, embodiments of an integrated level 10 in accordance with the invention can incorporate an accelerometer or other measuring means 18 such as dual axis accelerometer in a wireless device 11 or phone to function as a level. The dual axis accelerometer 18 can have an X axis and a Y axis. Such a device can be quite useful for a hobbyist or handyman. Of course, other means of measuring a deviation from a reference plane on the phone is contemplated herein. Such measuring devices enable the simulation of a level on a display 12 or alternatively or optionally provide audible feedback via a speaker 17 (for example) indicating a leveling function. The integrated level 10 can utilize a flat surface 15 of the phone as the reference plane. The flat surface 15 is a plane parallel to the Y axis of the accelerometer on the side of a housing 13 of the wireless device 11. Of course, other surfaces can alternatively be used as a reference plane such as the bottom of the housing 13 which can be parallel to the X axis of the accelerometer. The accelerometer 18 can measure static acceleration in the X and Y directions (as further described with reference to FIG. 2 below) and can be accurately placed in the wireless device 11 so that the accelerometer's X and Y axes are parallel (or orthogonal if desired) to the reference plane.

By placing the handset reference plane 15 over a measurement plane 20, the integrated level 10 can determine how far off it is from a perfect vertical line or horizontal plane. The display 12 of the integrated level 10 can provide a graphic user interface with a simulated level having a three segmented vertical bubble representation 16 and a three segmented horizontal bubble representation 14 that can simulate a common household level.

Dual axis accelerometers are widely available and aggressively priced. Analog Devices is an example of an accelerometer supplier that supports the functions required herein. The accuracy of the level can be calibrated in the factory by placing the wireless device in accurate horizontal and vertical positions. After calibration, a typical accelerometer will drift 0.1 mg/C, or 5 mg at −25 C if the radio was calibrated at +25 C. This turns into an error of only 0.28 deg. See attached file for ADXL 103 Analog Devices accelerometer specification.

Referring to FIG. 2, a dual axis accelerometer 18 such as the ADXL203 by Analog Devices is shown. The accelerometer 18 can be a high precision, low power, complete single and dual axis accelerometers with signal conditioned voltage outputs, all on a single monolithic IC. The ADXL203 by Analog Device can measure acceleration with a full-scale range of ±1.7 g and can measure both dynamic acceleration (e.g., vibration) and static acceleration (e.g., gravity). The typical noise floor is 110 g/Hz, allowing signals below 1 mg (0.06° of inclination) to be resolved in tilt sensing applications using narrow bandwidths (<60 Hz). The user can select the bandwidth of the accelerometer using capacitors CX and CY at the XOUT and YOUT pins. Bandwidths of 0.5 Hz to 2.5 kHz may be selected to suit the application.

The ADXL203 or the accelerometer 18 can contain a polysilicon surface micromachined sensor 22 and signal conditioning circuitry to implement an open-loop acceleration measurement architecture. The sensor 22 is a surface-micromachined polysilicon structure built on top of a silicon wafer. Polysilicon springs suspend the structure over the surface of the wafer and provide a resistance against acceleration forces. Deflection of the structure is measured using a differential capacitor that consists of independent fixed plates and plates attached to the moving mass. The fixed plates are driven by 180° out-of-phase square waves using the AC Amplifier 24. Acceleration will deflect the beam and unbalance the differential capacitor, resulting in an output square wave whose amplitude is proportional to acceleration. Phase sensitive demodulation techniques using demodulator 26 are then used to rectify the signal and determine the direction of the acceleration. The output of the demodulator 26 is amplified by amplifiers 28 and 29 and brought offchip through a 32 k resistor. At this point, the user can set the signal bandwidth of the device by adding a capacitor. This filtering improves measurement resolution and helps prevent aliasing.

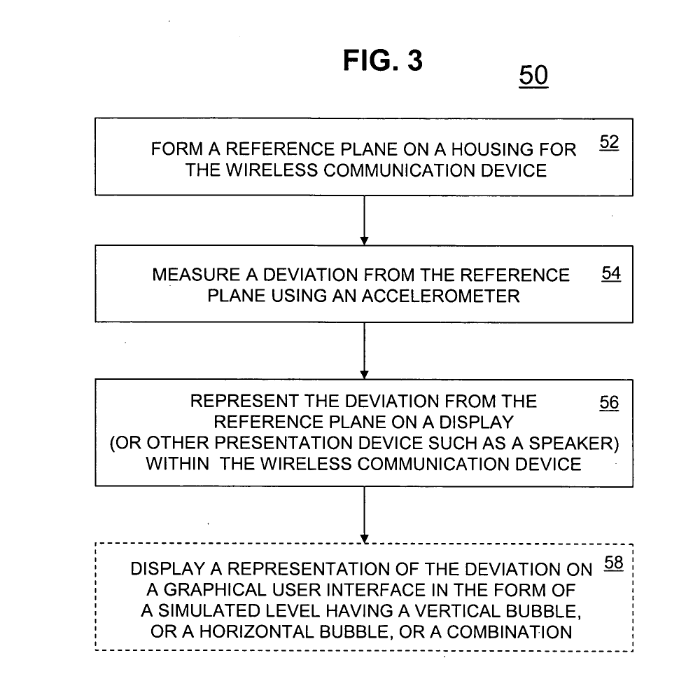

Referring to FIG. 3, a flow chart illustrating a method 50 of simulating a level function on a wireless communication device is shown. The method 50 can include the step 52 of forming a reference plane on a housing for the wireless communication device, measuring a deviation from the reference plane using an accelerometer at step 54, and representing the deviation from the reference plane on a display or other presentation device within the wireless communication device at step 56. Representing the deviation can optionally be done at step 58 by displaying a representation of the deviation on a graphical user interface in the form of a simulated level. The simulated level can have a vertical bubble, or a horizontal bubble, or a combination and in one embodiment can have a representation of a three segmented vertical bubble representation with a three segmented horizontal bubble representation as shown in FIG. 1.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

1. An integrated level in a wireless device, comprising:
a wireless transceiver within a housing;
a processor coupled to the wireless transceiver;
a presentation device coupled to the processor; and
an accelerometer coupled to the processor, wherein the presentation device serves to simulate the function of a level.

2. The integrated level of claim 1, wherein a reference plane can be added to the housing for proper level operation.

3. The integrated level of claim 1, wherein the accelerometer measures static acceleration in X-Y directions.

4. The integrated level of claim 1, wherein the accelerometer is accurately placed in the housing so that X and Y axes are parallel to a reference plane.

5. The integrated level of 2, wherein the presentation device comprises a display.

6. The integrated level of claim 5, wherein by orienting the housing and the reference plane over a measurement plane, a determination of a deviation from a vertical plane or a horizontal plane becomes apparent on the display.

7. The integrated level of claim 5, wherein the display provides a graphic user interface with a simulated level having a three segmented vertical bubble representation and a three segmented horizontal bubble representation.

8. The integrated level of claim 1, wherein the presentation device is selected among a display and a audible presentation device.

9. A level, comprising:
a wireless communication device within a housing;
a display within the wireless communication device;
a means for measuring a deviation from a reference plane on the housing; and
a graphical user interface on the display for representing the deviation from the reference plane.

10. The level of claim 9, wherein the wireless communication device comprises a wireless transceiver coupled to a processor.

11. The level of claim 10, wherein the means for measuring comprises an accelerometer coupled to the processor, wherein the display serves to visually simulate the function of a level.

12. The level of claim 11, wherein the accelerometer measures static acceleration in X-Y directions.

13. The level of claim 11, wherein the accelerometer is accurately placed in the housing so that X and Y axes are parallel to a reference plane.

14. The level of claim 9, wherein by orienting the housing and the reference plane over a measurement plane, a determination of a deviation from a vertical plane or a horizontal plane becomes apparent on the display.

15. The level of claim 9, wherein the graphic user interface provides a simulated level having a three segmented vertical bubble representation and a three segmented horizontal bubble representation.

16. The level of claim 9, wherein the graphic user interface provides a simulated level having a vertical bubble representation.

17. The level of claim 9, wherein the graphic user interface provides a simulated level having a horizontal bubble representation.

18. A method of simulating a level function on a wireless communication device, comprising the steps of:
forming a reference plane on a housing for the wireless communication device;
measuring a deviation from the reference plane using an accelerometer; and
representing the deviation from the reference plane on a display within the wireless communication device.

19. The method of claim 18, wherein the step of representing comprising the step of displaying a representation of the deviation on a graphical user interface in the form of a simulated level.

20. The method of claim 19, wherein the display provides a graphic user interface with a simulated level having a three segmented vertical bubble representation and a three segmented horizontal bubble representation.
